(19) United States
(12) Patent Application Publication
(10) Pub. No.: US 2015/0154736 A1
(43) Pub. Date: Jun. 4, 2015

(54) Linking Together Scene Scans

(71) Applicant: Google Inc., (US)

(72) Inventors: Steven Maxwell SEITZ, Seattle, WA (US); Rahul Garg, Seattle, WA (US)

(73) Assignee: Google Inc., Mountain View, CA (US)

(21) Appl. No.: 13/721,643

(22) Filed: Dec. 20, 2012

Related U.S. Application Data
(60) Provisional application No. 61/577,973, filed on Dec. 20, 2011.

(51) Int. Cl. G06T 3/00

(52) U.S. Cl. CPC G06T 3/0087

(57) ABSTRACT

Systems, methods, and computer storage mediums are provided for linking scene scans. A method includes creating a first scene scan from a first group of photographic images. The first scene scan is created by aligning a set of common features captured between at least two photographic images in the first group, where the at least two photographic images in the first group may each be captured from a different optical center. The set of common features is aligned based on a similarity transform determined between the at least two photographic images. An area of at least one photographic image in the first group is then defined, at least in part, based on a user selection. A second scene scan is linked with the area defined in the at least one photographic image in the first group, where the second scene scan is created from a second group of photographic images.

This application claims the benefit of U.S. Provisional Application No. 61/577,973 filed Dec. 20, 2011, which is incorporated herein in its entirety by reference.

### FIELD

The embodiments described herein generally relate to organizing and navigating through groups of photographic images.

### BACKGROUND

Users wishing to stitch together a collection of photographic images captured from the same optical center may utilize a variety of computer programs that determine a set of common features in the photographic images and stitch the photographic images together into a single panorama. The photographic images may be aligned by matching the common features between the photographic images. These computer programs, however, are not designed to stitch photographic images together when the photographic images are captured from different optical centers. Panorama creation programs known in the art require that an image capture device rotate about the optical center of its lens, thereby maintaining the same point of perspective for all photographs. If the image capture device does not rotate about its optical center, its images may become impossible to align perfectly. These misalignments are known as parallax error.

To view these panoramas, panorama displaying computer programs allow users to navigate through multiple panoramas by using, for example, direction arrows displayed in a first panorama that, when selected, display a second panorama that was captured in a location approximately indicated by the direction arrow in the first panorama.

### BRIEF SUMMARY

The embodiments described herein include systems, methods, and computer storage mediums for linking scene scans. A method includes creating a first scene scan from a first group of photographic images. The first scene scan is created by aligning a set of common features captured between at least two photographic images in the first group, where the at least two photographic images in the first group may each be captured from a different optical center. The set of common features is aligned based on a similarity transform determined between the at least two photographic images in the first group. An area of at least one photographic image in the first group is then defined, at least in part, based on a user selection. A second scene scan is linked with the area defined in the at least one photographic image in the first group. The second scene scan is created from the second group of photographic images. The second scene scan is created by aligning a set of common features captured between at least two photographic images in the second group, where the at least two photographic images in the second group may each be captured from a different optical center. The set of common features is aligned based on a similarity transform determined between the at least two photographic images in the second group.

Further features and advantages of the embodiments described herein, as well as the structure and operation of various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A illustrates a first scene scan according to an embodiment.

FIG. 1B illustrates the scene scan in FIG. 1A with the viewport set to zoom into the scene scan.

FIG. 2 illustrates a second scene scan according to an embodiment.

FIG. 3A illustrates an example system for linking scene scans according to an embodiment.

FIG. 3B illustrates an example system for linking scene scans according to an embodiment.

FIG. 4 is a flowchart illustrating a method that may be used to create a scene scan from a group of photographic images according to an embodiment.

FIG. 5 illustrates an example computer in which the embodiments described herein, or portions thereof, may be implemented as computer-readable code.

### DETAILED DESCRIPTION

Embodiments described herein may be used to link scene scans. Each scene scan is created from a group of photographic images. The photographic images utilized by the embodiments include photographic images that may be captured from different optical centers. An optical center of two photographic images may be different when, for example, the photographic images are captured from different physical locations. A first scene scan is created by aligning common features captured in two or more photographic images. To align the photographic images, a similarity transform is determined based on the common features. Once the first scene scan is created, an area of the first scene scan is defined and the defined area is linked with a second scene scan. The second scene scan may be loaded from a database or created from a second group of photographic images.

In the following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The following detailed description refers to the accompanying drawings that illustrate embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

This Detailed Description is divided into sections. The first section describes scene scans that may created and linked according to an embodiment. The second and third sections describe example system and method embodiments, respectively, that may be used to link scene scans. The fourth section describes an example computer system that may be used to implement the embodiments described herein.

### Example Scene Scans

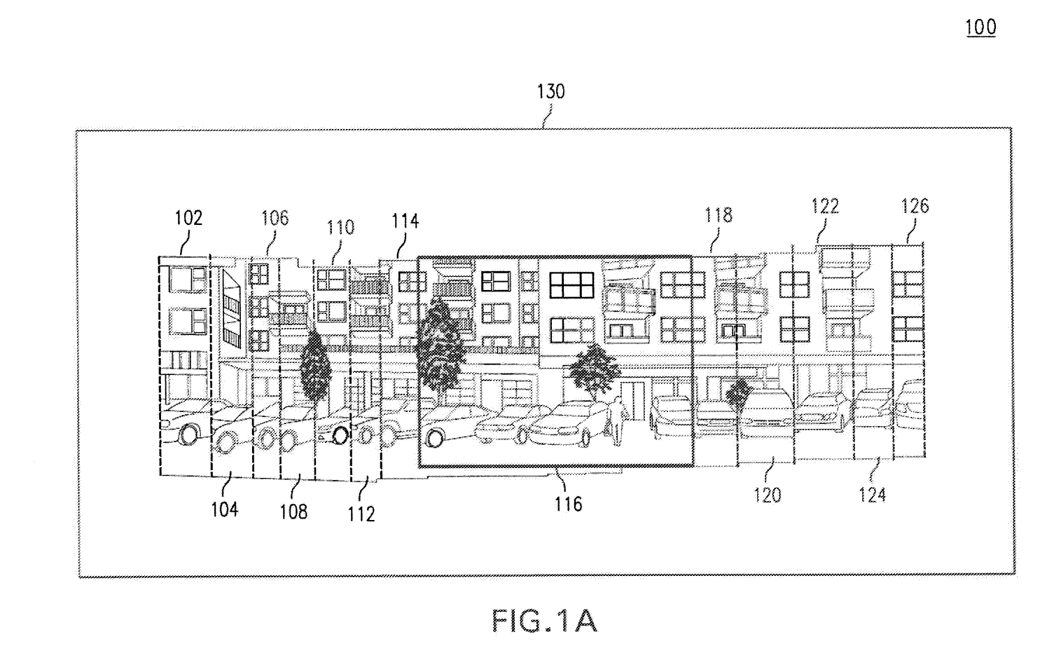

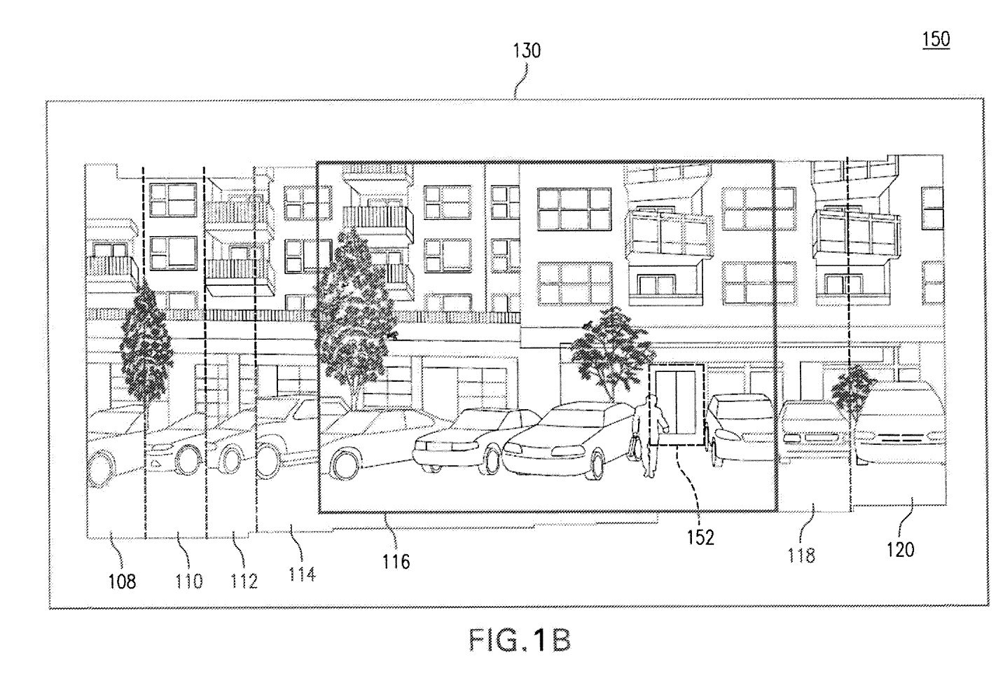

FIG. 1 illustrates scene scan 100 according to an embodiment. Scene scan 100 is created by overlapping photographic images 102, 104, 106, 108, 110, 112, 114, 116, 118, 120, 122, 124, and 126 on top of each other. Photographic images 102 126 may each be captured from a different optical center. In scene scan 100, for example, the optical center for each photographic image 102-126 changes in a horizontal direction as each image is captured. As a result, scene scan 100 shows a scene that is created by aligning each photographic image 102-126 based on common features captured in neighboring photographic images. While scene scan 100 shows a street, scene scans created according to the embodiments may include, for example, rooms in a structure, store aisles, or other navigable paths.

To create scene scan 100, photographic images 102-126 are each positioned on top of one another based on common features. For example, photographic images 114 and 1116 each capture a portion of the same building along a street. Once common features in the building are identified, photographic images 114 and 116 are position such that the common features align. Photographic images 102-112 and 118-126 are positioned in the same way. In scene scan 100, common features exist between photographic images 102 and 104, photographic images 104 and 106, photographic images 106 and 108, etc.

Scene scan 100 may be rendered on a display device such that the photographic image with an image center closest to the center of a viewport is placed on top. In FIG. 1, the image center of photographic image 116 is closest to the center of viewport 130 and thus, photographic image 116 is displayed on top of photographic images 102-114 and 118-126. A user interface may be utilized to allow a user to interact with scene scan 100. The user interface may allow a user to, for example, pan or zoom scene scan 100. If the user selects to pan scene scan 100, the photographic image with the image center closest to the center of viewport 130 may be moved to the top of the rendered photographic images. For example, if a user selects to pan along scene scan 100 to the left of photographic image 116, photographic image 114 may be placed on top of photographic image 116 when the image center of photographic image 114 is closer to the center of viewport 130 than the image center of photographic image 116.

FIG. 1B illustrates scene scan 150 which shows a zoomed-in version of scene scan 100 in viewport 130. Scene scan 150 shows photographic images 108-120 overlaid on top of each other such that the common features between photographic images 108-120 align. Scene scan 150 also shows defined area 152. Defined area 152 is based, at least in part, on a user selecting a portion of scene scan 150. While scene scan 150 shows defined area 152 on photographic image 116, defined area 152 may be placed on a neighboring photographic image that captures the same feature with defined area 152.

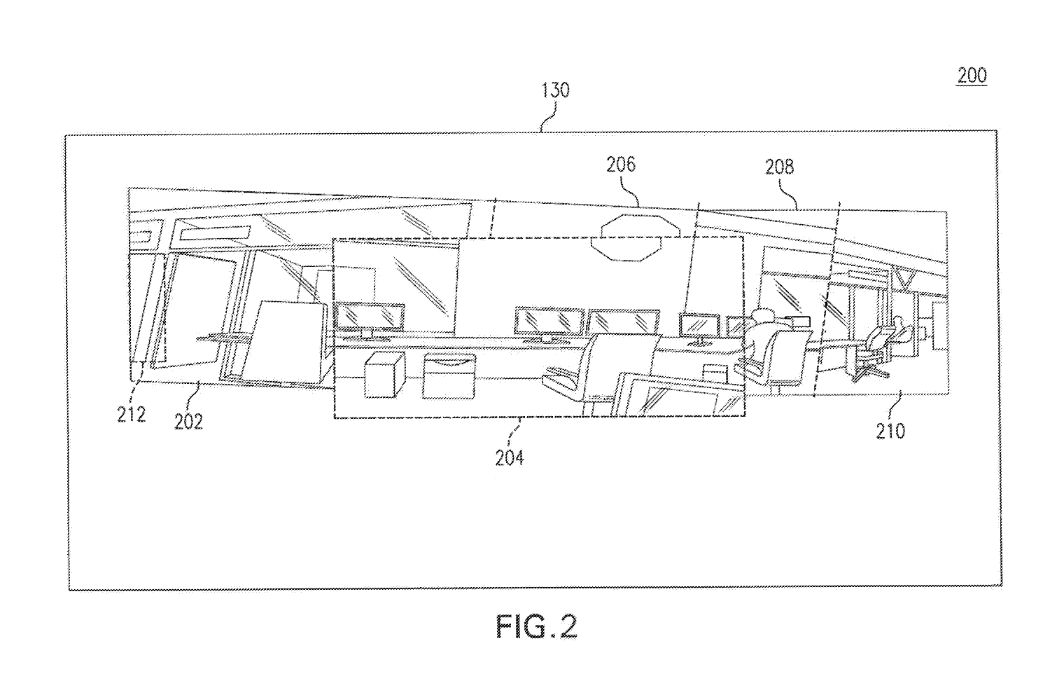

Defined area 150 may be used to link a second scene scan such as, for example, scene scan 200 embodied in FIG. 2. The link may occur automatically based on geolocation coordinates of the photographic images. The link may also occur manually, in part, as the user captures photographic images. For example, in some embodiments, after the user captures photographic images 102-126, the user may select defined area 152 and start a new scene scan. As the user captures photographic images in the new scene scan, one of the photographic image of the new scene scan may be automatically linked with defined area 152.

FIG. 2 illustrates a second scene scan 200 according to an embodiment. Scene scan 200 is made up of photographic images 202, 204, 206, 208, and 210. Scene scan 200 may be linked to scene scan 150 in FIG. 1B by defined area 152. Scene scan 200 may be navigated to by selecting defined area 152. Scene scan 200 also includes defined area 212. Defined area 212 may be created in the same manner as defined area 152 or may be created automatically when, for example, a link is created between defined area 152 and scene scan 200. Defined area 212 may link scene scan 200 to scene scan 150 or photographic image 116.

FIGS. 1A, 1B, and 2 are provided as examples and are not intended to limit the embodiments described herein.

### Example System Embodiments

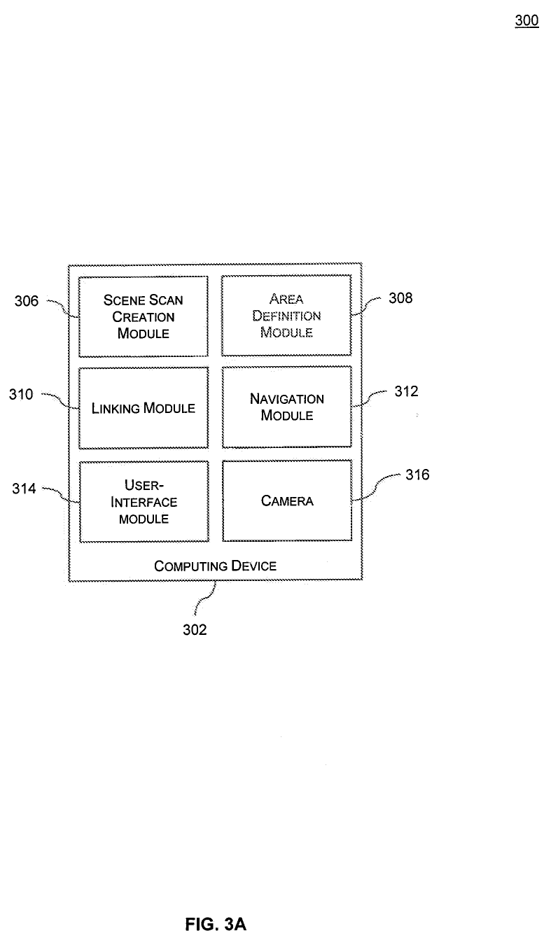

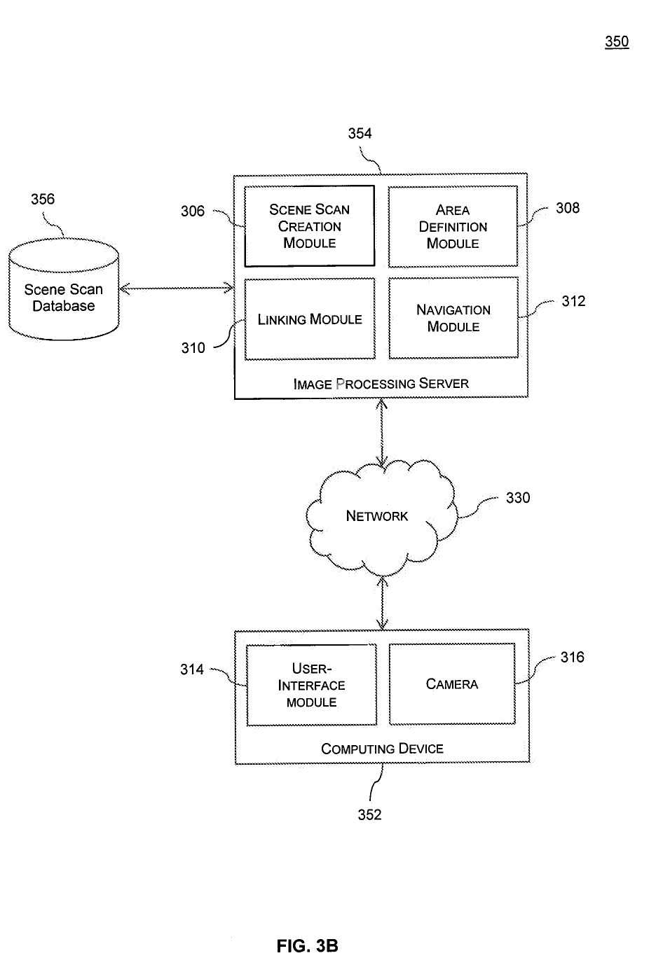

FIG. 3A illustrates an example system 300 for linking scene scans according to an embodiment. System 300 includes computing device 302. Computing device 302 includes scene scan creation module 306, area definition module 308, linking module 310, navigation module 312, user-interface module 314, and camera 316.

FIG. 3B illustrates an example system 350 for linking scene scans according to an embodiment. System 350 is similar to system 300 except that some functions are carried out by a server. System 350 includes computing device 352, image processing server 354, scene scan database 356, and network 330. Computing device 352 includes user-interface module 314, and camera 318. Image processing server 354 includes scene scan creation module 306, area definition module 308, linking module 310, and navigation module 312.

Computing devices 302 and 352 can be implemented on any computing device capable of processing photographic images. Computing devices 302 and 352 may include, for example, a mobile computing device (e.g. a mobile phone, a smart phone, a personal digital assistant (PDA), a navigation device, a tablet, or other mobile computing devices). Computing devices 302 and 352 may also include, but are not limited to, a central processing unit, an application-specific integrated circuit, a computer, workstation, a distributed computing system, a computer cluster, an embedded system, a stand-alone electronic device, a networked device, a rack server, a set-top box, or other type of computer system having at least one processor and memory. A computing process performed by a clustered computing environment or server farm may be carried out across multiple processors located at the same or different locations. Hardware can include, but is not limited to, a processor, memory, and a user interface display.

Computing devices 302 and 352 each include camera 316. Camera 316 may be implemented by any digital image capture device such as, for example, a digital camera or an image scanner. While camera 316 is included in computing devices 302 and 352, camera 316 is not intended to limit the embodiments in any way. Alternative methods may be used to acquire photographic images such as, for example, retrieving photographic images from a local or networked storage device.

Network 330 can include any network or combination of networks that can carry data communication. These networks can include, for example, a local area network (LAN) or a wide area network (WAN), such as the Internet. LAN and WAN networks can include any combination of wired (e.g., Ethernet) or wireless (e.g., Wi-Fi, 3G, or 4G) network components.

Image processing server 354 can include any server system capable of processing photographic images. Image processing server 354 may include, but is not limited to, a central processing unit, an application-specific integrated circuit, a computer, workstation, a distributed computing system, a computer cluster, an embedded system, a stand-alone electronic device, a networked device, a rack server, a set-top box, or other type of computer system having at least one processor and memory. A computing process performed by a clustered computing environment or server farm may be carried out across multiple processors located at the same or different locations. Hardware can include, but is not limited to, a processor, memory, and a user interface display. Image processing server 354 may position photographic images into scene scans and link the scene scans. The scene scans and links may be stored at, for example, scene scan database 356. Scene scans and links stored at scene scan database 356 may be transmitted to computing device 352 for display.

A. Scene Scan Creation Module

Scene scan creation module 306 is configured to create a scene scan from a group of photographic images. The scene scan is created by aligning a set of common features captured between at least two photographic images. The at least two photographic image may each be captured from a different optical center. The set of common features is aligned based on a similarity transform determined between the at least two photographic images. Scene scan creation module 306 may also create scene scans using the embodiments described in U.S. Provisional App. No. 61/577,931 (Attn. Dkt. No. 2525.8570000), filed on Dec. 20, 2011, and incorporated in its entirety by reference.

1. Feature Detection

To create a scene scan, scene scan creation module 306 may be configured to determine a set of common features between at least two photographic images. The set of common features include, for example, at least a portion of an object captured in each of the photographic images. Each photographic image may be captured from a different optical center. The set of common features may include, for example, an outline of a structure, intersecting lines, or other features captured in the photographic images. Features may be detected using any number of feature detection and description methods known to those of skill in the art such as, for example, Features from Accelerated Segment Test (“FAST”), Speed Up Robust Features (“SURF”), or Scale-invariant feature transform (“SIFT”). In some embodiments, two features are determined between the photographic images and other features are thereafter determined and used to verify that the photographic images captured, at least a portion, of the same subject matter.

In some embodiments, the set of common features is determined between two photographic images as the photographic images are being captured by computing devices 302 or 352. In some embodiments, as a new photographic image is captured, a set of common features is determined between the newly captured photographic image and the next most recently captured photographic image. In some embodiments, the set of common features is determined between the newly captured photographic image and a previously captured photographic image.

2. Similarity Transform

Once a set of common features is determined between at least two photographic images, scene scan creation module 308 may be configured to determine a similarity transform between the common features. The similarity transform is determined by calculating a rotation factor, a scaling factor, and a translation factor that, when applied to each or both of the photographic images, align the set of common features between the photographic images.

a. Rotation Factor

The rotation factor describes a rotation that, when applied to either or both of the photographic images, aligns, at least in part, the common features between the photographic images. The rotation factor may be determined between the photographic images when, for example, the photographic images are captured about parallel optical axes but at different rotation angles applied to each optical axis. For example, if a first photographic image is captured at an optical axis and at a first angle of rotation and a second photographic image is captured at a parallel optical axis but at a second angle of rotation, the image planes of the first and second photographic images may not be parallel. If the image planes are not parallel, the rotation factor may be used to rotate either or both of the photographic images such that the set of common features, at least in part, align. For example, if the rotation factor is applied to the second photographic image, the set of common features will align, at least in part, when the set of common features appear at approximately the same rotation angle.

b. Scaling Factor

The scaling factor describes a zoom level that, when applied to either or both of the photographic images, aligns, at least in part, the common features between the photographic images. For example, if the common features between the photographic images are at different levels of scale, the common features between the photographic images may appear at different sizes. The scale factor may be determined such that, when the scale factor is applied to either or both of the photographic images, the common features are approximately at the same level of scale.

c. Translation Factor

The translation factor describes a change in position that, when applied to either or both of the photographic images, aligns, at least in part, the common features between the photographic images. For example, in order to align the common features between the photographic images, the translation factor may be used to modify the coordinates of either or both of the photographic images so that the photographic images are positioned to cause the set of common features to overlap. The translation factor may utilize, for example, an x,y coordinate system or other coordinate systems such as, for example, latitude/longitude or polar coordinates.

B. Area Definition Module

Area definition module 308 is configured to define an area of at least one photographic image in a scene scan. The area may be defined, at least in part, based on a user selection. In some embodiments, the user selection may be made by a user indicating a point, a box, a series of lines, a circle, or another shape within a user interface used to display the scene scan. In some embodiments, the user may select a feature captured in the photographic image such as, for example, a door, a street, a building, or other structures or part of structures. For example, if a user selects a portion of a door, area definition module 308 may define the area as the door. In some embodiments, features in the photographic image may be detected and displayed to the user whereby the may then select one of the features.

The area may also be defined automatically based on the common features that exist between two photographic images. For example, if an area is defined in a first photographic image, area definition module 308 may determine the features within the area and locate corresponding features in a second photographic image. The corresponding features may be used to define an area of the second photographic image. The defined area of the second photographic image may behave a similar way to the defined area in the first photographic image. The features within a defined area may also be determined in other photographic images using the feature detection methods described above.

Area definition module 308 may also define an area in a photographic image automatically when, for example, the photographic image is selected to be linked to from another scene scan. The area may be defined at the bottom or at an edge of the photographic image. The area may be linked automatically back to the other scene scan or a photographic image in the other scene scan.

C. Linking Module

Linking module 310 is configured to link a second scene scan with an area defined in a photographic image of a first scene scan. The link may be associated with the defined area and stored in an associated data structure. The link may include, for example, a URL, a memory address pointer, a filename, or any other type of linking method known to those of skill in the art. The link may be stored in a database with the scene scan such as, for example, scene scan database 356.

Linking module 310 may link a second scene scan by linking directly to a photographic image in the second scene scan. In some embodiments, the photographic image that is linked to is determined by a user. For example, a user may capture a group of photographic images that are arranged into a first scene scan. The user may then select an area on one of the photographic images of the first scene scan and indicate that a second scene scan will be created. The first photographic image in the second scene scan may then automatically be linked with the selected area in the first scene scan.

A link between a first and second scene scan may also be determined automatically based on geolocation coordinates of the photographic images in the first and second scene scan. Linking module 310 may search for scene scans having photographic images with neighboring geolocation coordinates. If a neighboring scene scan is located, the scene scans may be linked through the photographic image in each scene scan with the closest geolocation coordinates.

D. Navigation Module

Navigation module 312 is configured to navigate from a first scene scan to a second scene scan based, at least in part, on a user selection within an area defined in the first scene scan. Navigation module 312 may also navigate from the first scene scan to a linked photographic image in the second scene scan. The navigation may be shown by rendering the second scene scan in a viewport used to display the first scene scan. The viewport may be shown on a display device connected to computer system 302 or 352. Before rendering, the second scene scan may be loaded from a database such as, for example, scene scan database 356. The second scene scan may also be loaded from a file or other data storage unit. Navigation module 312 may receive an indication to navigate to the second scene scan from, for example, user interface module 314.

E. User-Interface Module

In some embodiments, user-interface module 314 may be configured to display at least a portion of the scene scan that falls within a viewport used to display the rendered photographic images. The viewport is a window or boundary that defines the area that is displayed on a display device. The viewport may be configured to display all or a portion of a scene scan or may be used to zoom or pan the scene scan.

In some embodiments, user-interface module 314 may also be configured to receive user input to navigate through the scene scan. The user input may include, for example, commands to pan through the photographic image, change the order of the overlap between photographic images, zoom into or out of the photographic images, or select portions to the scene scan to interact with such as, for example, an area defined by area definition module 308.

In some embodiments, the scene scan may be displayed as photographic images overlapped on top of each other based on the common features between the photographic images. User interface module 314 may show the photographic images in the scene scan based on the distance between the image center of a photographic image and the center of the viewport. For example, when the image center of a first photographic image is closest to the center of a viewport used to display the scene scan, user-interface module 314 may position the first photographic image over a second photographic image. Similarly, when the image center of the second photographic image is closest to the center of the viewport, user-interface module 314 may be configured to position the second photographic image over the first photographic image. In some embodiments the order of overlap between the photographic images is determined as the user pans, zooms, or interacts with the scene scan.

In some embodiments, user-interface module 314 is configured to position each photographic image in a scene scan such that the photographic image with the image center closest to the center of a viewport is placed over the photographic image with the image center next closest to the center of the viewport. For example, if a first photographic image has an image center closest to the center of the viewport, user-interface module 314 will place the first photographic image on top of all other photographic images in the scene scan. Similarly, if a second photographic image has an image center next closest to the center of the viewport, the second photographic image will be positioned over all but the first photographic image.

Various aspects of embodiments described herein can be implemented by software, firmware, hardware, or a combination thereof. The embodiments, or portions thereof, can also be implemented as computer-readable code. The embodiment in systems 300 and 350 are not intended to be limiting in any way.

### Example Method Embodiments

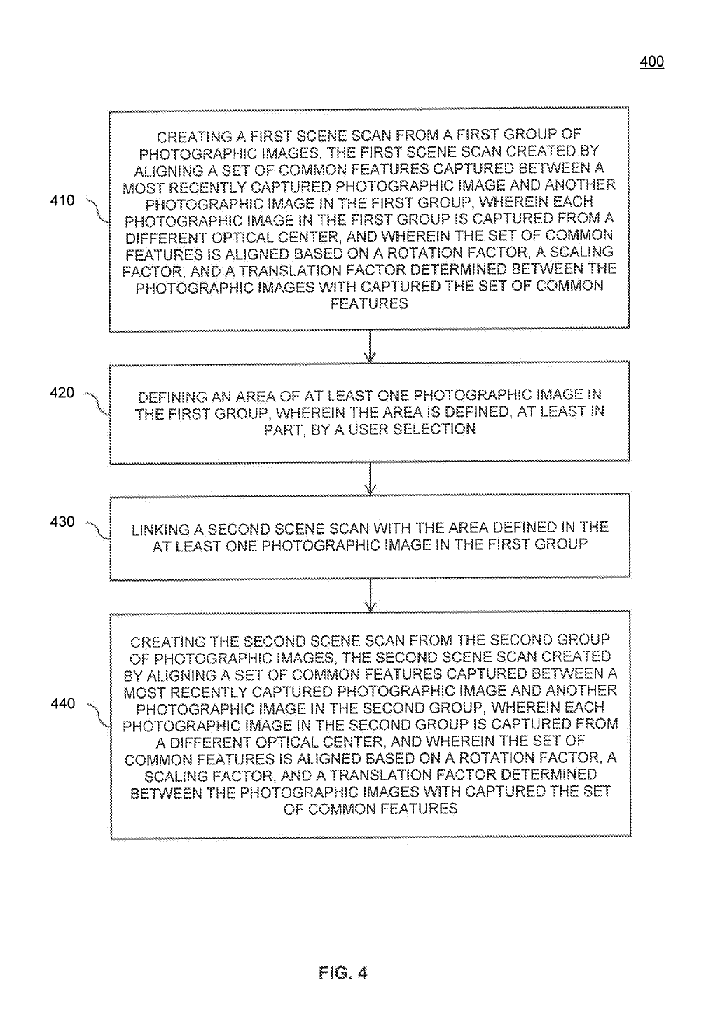

FIG. 4 is a flowchart illustrating a method 400 that may be used to link scene scans. Each scene scan is created from a group of photographic images. While method 400 is described with respect to an embodiment, method 400 is not meant to be limiting and may be used in other applications. Additionally, method 400 may be carried out by, for example, system 300 in FIG. 3A or system 350 in FIG. 3B.

Method 400 creates a first scene scan from a first group of photographic images (stage 410). The first scene scan is created by aligning a set of common features captured between at least two photographic images in the first group. The features may include at least a portion of an object captured in each of the two photographic images, where each of the two photographic images may be captured from different optical centers. Any feature detection and description method may be used to determine the set of common features between the photographic images. Such methods may include, for example, Features from Accelerated Segment Test (“FAST”), Speed Up Robust Features (“SURF”), or Scale-invariant feature transform (“SIFT”). These feature detection methods are merely provided as examples and are not intended to limit the embodiments in any way. Once the set of common features are determined between the at least two photographic images, an alignment of the set of common features is determined based on a similarity transform. Stage 410 may be carried out by, for example, scene scan creation module 306 embodied in systems 300 and 350.

Method 400 then defines an area of at least one photographic image in the first group (stage 420). The area is defined, at least in part, based on a user selection. The area may be defined by the user selecting a point on the photographic image such as, for example, a door or a building. The area may also be defined by indicating the shape of a selection area. Stage 420 may be carried out by, for example, area definition module 308 embodied in systems 300 and 350.

Once an area of the first scene scan is defined, method 400 links a second scene scan with the area defined in the at least one photographic image in the first group. The second scene scan may be linked by, for example, a URL, a memory pointer, a file name, or other linking method. Stage 430 may be carried out by, for example, linking module 310 embodied in systems 300 and 350.

Method 400 then creates the second scene scan from a second group of photographic images (stage 440). The second scene scan is created by aligning a set of common features captured between at least two photographic images in the second group, where the at least two photographic images in the second group may each be captured from a different optical center. The set of common features is aligned based on a similarity transform determined between the at least two photographic images. The second scene scan may be created while the user captures the photographic images in the second group. Stage 440 may be carried out by, for example, scene scan creation module 306 embodied in systems 300 and 350.

### Example Computer System

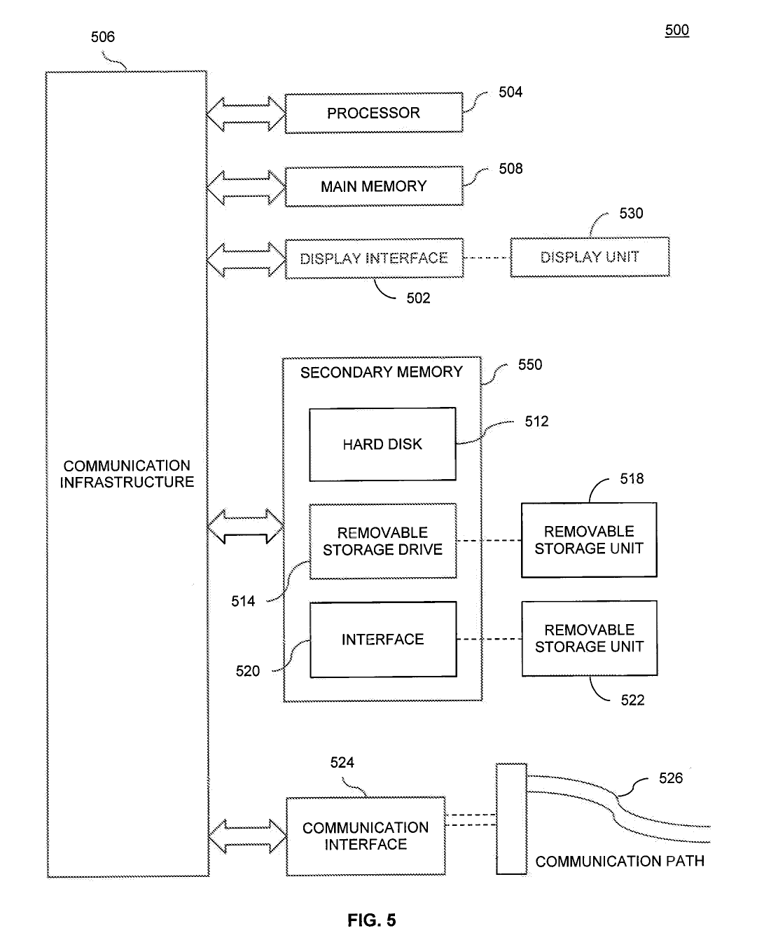

FIG. 5 illustrates an example computer 500 in which the embodiments described herein, or portions thereof, may be implemented as computer-readable code. For example, scene scan creation module 306, area definition module 308, linking module 310, navigation module 312, and user-interface module 314 may be implemented in one or more computer systems 500 using hardware, software, firmware, computer readable storage media having instructions stored thereon, or a combination thereof.

One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments are described in terms of this example computer system 500. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 504 may be a single processor in a multi-core/multiprocessor system, such system operating alone, or in a cluster of computing devices operating in a cluster or server farm. Processor device 504 is connected to a communication infrastructure 506, for example, a bus, message queue, network, or multi-core message-passing scheme. Computer system 500 may also include display interface 502 and display unit 530.

Computer system 500 also includes a main memory 508, for example, random access memory (RAM), and may also include a secondary memory 510. Secondary memory 510 may include, tor example, a hard disk drive 512, and removable storage drive 514. Removable storage drive 514 may include a floppy disk drive, a magnetic tape drive, an optical disk drive, a flash memory drive, or the like. The removable storage drive 514 reads from and/or writes to a removable storage unit 518 in a well-known manner. Removable storage unit 518 may include a floppy disk, magnetic tape, optical disk, flash memory drive, etc. which is read by and written to by removable storage drive 514. As will be appreciated by persons skilled in the relevant art, removable storage unit 518 includes a computer readable storage medium having stored thereon computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 518, removable storage unit 522, and a hard disk installed in hard disk drive 512. Computer storage medium and computer readable storage medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via communications interface 524. Such computer programs, when executed, enable computer system 500 to implement the embodiments described herein. In particular, the computer programs, when executed, enable processor device 504 to implement the processes of the embodiments, such as the stages in the method illustrated by flowchart 400 of FIG. 4, discussed above. Accordingly, such computer programs represent controllers of computer system 500. Where an embodiment is implemented using software, the software may be stored in a computer storage medium and loaded into computer system 500 using removable storage drive 514, interface 520, and hard disk drive 512, or communications interface 524.

Embodiments of the invention also may be directed to computer program products including software stored on any computer readable storage medium. Such software, when executed in one or more data processing device, causes a data processing device(s) to operate as described herein. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### Conclusion

The Summary and Abstract sections may set forth one or more but not all embodiments as contemplated by the inventor(s), and thus, are not intended to limit the present invention and the appended claims in any way.

The foregoing description of specific embodiments so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described example embodiments.

What is claimed is:

1. A computer-implemented method for linking scene scans, each scene scan created from a group of photographic images, the method comprising:
creating, by at least one computer processor, a first scene scan from a first group of photographic images, the first group of photographic images including at least one photographic image captured from a different optical center, wherein the first scene scan is created by aligning a set of common features captured between at least two photographic images in the first group, and wherein the set of common features is aligned based on a similarity transform determined between the at least two photographic images;
defining, by at least one computer processor, an area of at least one photographic image in the first group, wherein the area is defined, at least in part, based on a user selection;
linking, by at least one computer processor, a second scene scan with the area defined in the at least one photographic image in the first group; and
creating, by at least one computer processor, the second scene scan from a second group of photographic images, the second group of photographic images including at least one photographic image captured from a different optical center, wherein the second scene scan is created by aligning a set of common features captured between at least two photographic images in the second group, and wherein the set of common features is aligned based on a similarity transform determined between the at least two photographic images.

2. The computer-implemented method of claim 1, wherein defining the area of at least one photographic image includes defining a corresponding area in another photographic image in the first group.

3. The computer-implemented method of claims 2, wherein the defining the corresponding area includes locating a feature captured in the defined area and locating a matching feature in the corresponding area.

4. The computer-implemented method of claims 3, wherein linking the second scene scan includes linking a first captured photographic image in the second scene scan with the corresponding area.

5. The computer-implemented method of claims 1, wherein linking the second scene scan includes linking a first captured photographic image in the second scene scan with the defined area in the at least one photographic image in the first group.

6. The computer-implemented method of claim 1, further comprising:
navigating from the first scene scan to the at least one linked photographic image in the second scene scan based, at least in part, on a user selection within the defined area or the corresponding area.

7. The computer-implemented method of claim 1, wherein linking the second scene scan includes linking a digital file containing the second scene scan with the area defined in the at least one photographic image in the first group.

8. The computer-implemented method of claim 1, wherein the at least two photographic images in the first group include a most recently captured photographic image and a previously captured photographic image, wherein an order of capture is determined by a time value associated with each photographic image.

9. A computer system for linking scene scans, each scene scan created from a group of photographic images, the method comprising:
a scene scan creation module configured to:
create a first scene scan from a first group of photographic images, the first group of photographic images including at least one photographic image captured from a different optical center, wherein the first scene scan is created by aligning a set of common features captured between at least two photographic images in the first group, and wherein the set of common features is aligned based on a similarity transform determined between the at least two photographic images
create a second scene scan from a second group of photographic images, the second group of photographic images including at least one photographic image captured from a different optical center, wherein the second scene scan is created by aligning a set of common features captured between at least two photographic images in the second group, and wherein the set of common features is aligned based on a similarity transform determined between the at least two photographic images.
an area definition module configured to define an area of at least one photographic image in the first group, wherein the area is defined, at least in part, based on a user selection; and
a linking module configured to link a second scene scan with the area defined in the at least one photographic image in the first group; and
at least one computer processor configured to execute at least one of the scene scan creation module, the area definition module, and the linking module.

10. The computer system of claim 9, wherein the area definition module is further configured to define a corresponding area in another photographic image in the first group.

11. The computer system of claims 10, wherein the area definition module is further configured to define the corresponding area by locating a feature captured in the defined area and locating a matching feature in the corresponding area.

12. The computer system of claims 11, wherein the linking module is further configured to link a first captured photographic image in the second scene scan with the corresponding area.

13. The computer system of claims 9, wherein the linking module is further configured to link a first captured photographic image in the second scene scan with the defined area in the at least one photographic image in the first group.

14. The computer system of claim 9, further comprising:
a navigation module configured to navigate from the first scene scan to the at least one linked photographic image in the second scene scan based, at least in part, on a user selection within the defined area or the corresponding area.

15. The computer system of claim 9, the linking module is further configured to link a digital file containing the second scene scan with the area defined in the at least one photographic image in the first group.

16. The computer system of claim 9, wherein the at least two photographic images in the first group include a most recently captured photographic image and a previously captured photographic image, wherein an order of capture is determined by a time value associated with each photographic image.

17. A computer-implemented method for linking scene scans comprising:
creating, by at least one computer processor, a plurality of scene scans, each scene scan created from a respective collection of photographic images that includes at least two photographic images, each image captured from a different optical center, wherein each scene scan is created by aligning a set of common features captured between at least two photographic images in the respective collection, and wherein the set of common features is aligned based on a similarity transform determined between the at least two photographic images;
defining, by at least one computer processor, one or more areas of the photographic images included in a first respective scene scan, wherein the one or more areas are defined, at least in part, based on user selections;
linking, by at least one computer processor, one respective scene scan with each of the one or more defined areas.

18. The computer-implemented method of claim 17, wherein defining the one or more area includes defining a corresponding area in another photographic image included in the first respective scene scan.

19. The computer-implemented method of claims 18, wherein defining the corresponding area includes locating a feature captured in the defined area and locating a matching feature in the corresponding area.

20. The computer-implemented method of claims 19, wherein linking the one respective scene scan includes linking a first photographic image in the one respective second scene scan with the defined area and the corresponding area.
